(19) United States
(12) Patent Application Publication
(10) Pub. No.: US 2025/0385525 A1
(43) Pub. Date: Dec. 18, 2025

(54) INTEGRATED SOLAR AND BATTERY SYSTEMS WITH VIRTUAL POWER POINT TRACKING

(71) Applicant: REON Technology, Inc., Chelmsford, MA (US)

(72) Inventors: Tiegeng Ren, Westford, MA (US); Xuanhang Zhang, Austin, TX (US)

(73) Assignee: REON Technology, Inc., Chelmsford, MA (US)

(21) Appl. No.: 19/313,919

(22) Filed: Aug. 29, 2025

Related U.S. Application Data
(63) Continuation-in-part of application No. 18/385,439, filed on Oct. 31, 2023.
(63) Continuation-in-part of application No. 18/137,471, filed on Apr. 21, 2023.
(63) Continuation-in-part of application No. 18/115,811, filed on Mar. 1, 2023.
(60) Provisional application No. 63/315,550, filed on Mar. 2, 2022.
(60) Provisional application No. 63/333,708, filed on Apr. 22, 2022.
(60) Provisional application No. 63/333,708, filed on Apr. 22, 2022.
(60) Provisional application No. 63/334,106, filed on Apr. 23, 2022.
(60) Provisional application No. 63/334,160, filed on Apr. 24, 2022.
(60) Provisional application No. 63/334,160, filed on Apr. 24, 2022.
(60) Provisional application No. 63/422,464, filed on Nov. 4, 2022.
(60) Provisional application No. 63/534,791, filed on Aug. 25, 2023.
(60) Provisional application No. 63/536,514, filed on Sep. 5, 2023.
(60) Provisional application No. 63/691,350, filed on Sep. 6, 2024.

(51) Int. Cl. H02J 3/38; H02J 3/32; H02J 3/46; H02J 13/00

(52) U.S. Cl. CPC H02J 3/381; H02J 3/32; H02J 3/46; H02J 13/00002; H02J 13/0004; H02J 2300/26

(57) ABSTRACT

A plurality of photovoltaic (PV) power sources is accessed. The PV power sources are configured using one or more series connections. Each PV power source of the PV power sources includes voltage sensing and current sensing. Bypassing each PV power source is enabled. The bypassing occurs at each PV power source and is performed by a distributed controller-switch at each PV power source. A battery management system is coupled to the PV power sources. The battery management system provides a configurable variable load voltage to the PV power sources. The voltage and the current that are sensed are monitored at each PV power source of the PV power sources. The bypassing of each PV power source and the variable load voltage of the battery management system are configured. The configuring enables PV power source power point tracking.

### RELATED APPLICATIONS

This application claims the benefit of U.S. provisional patent applications “Integrated Solar And Battery Systems With Virtual Power Point Tracking” Ser. No. 63/691,350, filed Sep. 6, 2024.

This application is also a continuation-in-part of U.S. patent application “Software-Defined Energy Storage System Interface” Ser. No. 18/115,811, filed Mar. 1, 2023, which claims the benefit of U.S. provisional patent applications “Software-Defined Energy Storage System Interface” Ser. No. 63/334,106, filed Apr. 23, 2022, “Battery System Management Using Cell State” Ser. No. 63/333,708, filed Apr. 22, 2022, “Battery Performance Tracking Across Battery Cells” Ser. No. 63/334,160, filed Apr. 24, 2022, and “Dynamic Control Of A Disparate Battery System” Ser. No. 63/315,550, filed Mar. 2, 2022.

This application is also a continuation-in-part of U.S. patent application “Battery Performance Tracking Across Battery Cells” Ser. No. 18/137,471 filed Apr. 21, 2023, which claims the benefit of U.S. provisional patent applications “Battery System Management Using Cell State” Ser. No. 63/333,708, filed Apr. 22, 2022, and “Battery Performance Tracking Across Battery Cells” Ser. No. 63/334,160, filed Apr. 24, 2022.

This application is also a continuation-in-part of U.S. patent application “Battery Management System With Controlled Replacement” Ser. No. 18/385,439, filed Oct. 31, 2023, which claims the benefit of U.S. provisional patent applications “Battery Management System With Controlled Replacement” Ser. No. 63/422,464, filed Nov. 4, 2022, “Distributed Power System For Management And Control” Ser. No. 63/534,791, filed Aug. 25, 2023, and “Battery Management System With Low Latency” Ser. No. 63/536,514, filed Sep. 5, 2023.

Each of the foregoing applications is hereby incorporated by reference in its entirety.

### FIELD OF ART

This application relates generally to power management and more particularly to integrated solar and battery systems with virtual power point tracking.

### BACKGROUND

The global demand for energy that is economically and environmentally sustainable is spurring the development of alternative, renewable energy sources. These “green” sources derive from renewable sources including solar, wind, geothermal and wave action sources. Even old technologies such as tidal mills capture water at high tide which can be used to produce energy at low tide. A weakness of these alternative sources is that the sources do not produce sufficient energy 24 hours a day. Solar panels produce abundant power on a sunny day, but little power on cloudy days, and minuscule power at night. Windmills only produce energy from wind when the wind is blowing. Geothermal technologies are best sited at geographic locations where geothermal energy is readily available. Other energy sources such as burning of biomass or biogas have been used, but concern remains that the burning produces carbon dioxide, ash, and other undesirable byproducts. Thus, techniques for storage of energy from renewable sources are garnering great interest globally.

Power delivery technology has evolved. Direct current (DC) electricity was commercialized before alternating current (AC) electricity, but AC power became popular because it can easily and efficiently be converted into higher or lower voltages. The competition between DC and AC was effectively settled when the 1893 Chicago World's Fair chose to power electric lights across the exhibition using an AC system. Support for power delivery technologies has also evolved. Historically, electricity delivery was achieved with copper wrapped with minimal cotton insulation. Sockets, switch handles, and fuse blocks were made of wood, and no voltage regulators were in place, so lights would dim and brighten based on demand on the electrical grid. Knob and tube wiring gave way to flexible armored cabling, which offered better wire protection. Later, electricians used rugged metal conduit, but the wiring was ungrounded. In 1965, grounded wiring became the standard for household wiring. When combined with circuit fault interrupters and circuit breakers, the safety of electrical wiring has vastly improved.

The demand for electricity has continued to increase. The convenience and popularity of household appliances, farm equipment including refrigeration, and other health and safety improvements led to nearly every home in the U.S. being supplied with electricity by 1960. Now, modern appliances and personal electronic devices that are widely considered essential to modern life all require electricity. While electrical energy uses continually expand, electricity production has developed more slowly. In areas where natural resources were readily available, waterpower or steam were used to drive turbines to generate electricity. Coal, oil, wind, natural gas, or nuclear reactors are now used to drive massive turbines to supply the world's electricity needs. Solar energy, tidal power, and geothermal sources are also tapped to add to our growing demand.

### SUMMARY

Rechargeable batteries are commonly found in personal electronic devices, tools, vehicles, mobility devices, uninterruptable power supplies, and other familiar devices. Many of the most popular rechargeable batteries are lithium based, including lithium ion, lithium iron phosphate, and lithium-ion polymer batteries. Lithium batteries possess high energy density, charge quickly, and are relatively lightweight compared to other rechargeable technologies such as sealed lead acid. Lithium batteries can operate in extreme temperatures and can be recharged many more times than other rechargeable battery types. However, lithium batteries are significantly more expensive than other rechargeable batteries and can degrade significantly if overcharged. Lithium batteries can also present serious safety concerns such as explosion or fire. Hazards are caused by the formation of lithium dendrites during the recharging process. Lithium dendrites are small, rigid, tree-like structures that grow inside a lithium battery. The dendrites resemble and are sometimes referred to as “whiskers.” These metallic microstructures form on the negative electrode or cathode during the charging process. Lithium dendrites can cause significant harm by piercing the battery's separator. This can lead to unwanted chemical reactions between the electrolyte and the lithium within the battery. The reactions cause premature battery failure, which can result in catastrophic consequences.

Techniques for solar and battery system integration are disclosed. A plurality of photovoltaic (PV) power sources is accessed. The PV power sources can include solar panels. The plurality of PV power sources is configured using one or more series connections. The series connection of solar panels can be used to obtain a desired voltage. The series connections of PV power sources can be configured using parallel connections. The parallel connections of the series connections of PV power sources can be used to obtain a desired amperage. Each PV power source of the plurality of PV power sources includes voltage sensing and current sensing. The sensing can be used to monitor PV power source operation, health, etc. Bypassing can be enabled for each PV power source of the plurality of PV power sources, where the bypassing occurs at each PV power source. The bypassing can be accomplished using a PV power source in a series connection of power sources, or can exclude the PV power source. The bypassing is performed by a distributed controller-switch at each PV power source. The distributed controller-switch comprises a bypass switch, a series switch, one or more sensors, and a control module. A battery management system is coupled to the plurality of PV power sources. The battery management system can individually control each distributed controller-switch using a system controller integrated in the battery management system. The battery management system further manages battery cells that can store power from the PV power sources, supplement or replace power provided to a load, etc. The battery management system provides a configurable variable load voltage to the plurality of PV power sources. A voltage and a current are sensed at each PV power source of the plurality of PV power sources. The sensed voltage and the sensed current are monitored. The bypassing is configured for each PV power source of the plurality of PV power sources and the variable load voltage of the battery management system. The configuring enables PV power source power point tracking. The power point tracking provides source current/load voltage impedance matching.

A method for power management is disclosed comprising: accessing a plurality of photovoltaic (PV) power sources, wherein the plurality of PV power sources is configured using one or more series connections, and wherein each PV power source of the plurality of PV power sources includes voltage sensing and current sensing; enabling bypassing each PV power source of the plurality of PV power sources, wherein the bypassing occurs at each PV power source, and wherein the bypassing is performed by a distributed controller-switch at each PV power source; coupling a battery management system to the plurality of PV power sources, wherein the battery management system provides a configurable variable load voltage to the plurality of PV power sources; monitoring the voltage and the current that are sensed at each PV power source of the plurality of PV power sources; and configuring the bypassing of each PV power source of the plurality of PV power sources and the variable load voltage of the battery management system, wherein the configuring enables PV power source power point tracking.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for integrated solar and battery systems with virtual power point tracking.

FIG. 2 is a flow diagram for a bypass configuration.

FIG. 3 is a block diagram for a distributed control and management system for direct current (DC) systems.

FIG. 4 is a block diagram of a distributed controller.

FIG. 5 is an infographic showing columns for battery cells and switches in a battery system.

FIG. 6 is a system block diagram for a battery management system with in situ cell rejuvenation.

FIG. 7 is a system diagram for an integrated solar and battery system with virtual power tracking.

### DETAILED DESCRIPTION

Photovoltaic (PV) cells, or “solar panels,” are used to convert high intensity light such as sunlight into electrical energy. The use of PV cells has accelerated in the last few decades. The accelerated PV cell use has been driven in part by the need to reduce reliance on fossil fuels for electrical energy generation, and further by the strong desire to develop environmentally friendly sources of electrical energy. While other renewable sources of energy are being developed based on wind power, wave action, and geothermal energy sources, for example, solar panels can be deployed more widely and generally for lower cost. A homeowner in a suburban setting can often set up solar panels on a building roof or in a yard where local ordinances restrict the installation of wind turbines. The solar panels can also be used in geographic locations away from shorelines adjacent to constant, sufficient wave action, or locations without geothermal activity. Further promoting PV cell usage are government energy subsidies and tax credits, reduced panel cost, and wider availability of the panels.

The PV cells are based on semiconductor materials that exhibit the photovoltaic effect. The photovoltaic effect generates a voltage and a current when the semiconductor is exposed to high intensity light such as sunlight. A major challenge to the use of PV cells, as with many renewable energy sources, is the fact that solar energy is not always available. Seasonal changes impact the relative angle of elevation of the sun above the horizon. Cloud cover and precipitation further limit the amount of light available for electrical energy generation. Solar panels do not operate at night. Thus, PV cells can be used in conjunction with other energy sources such as batteries. By integrating solar systems and battery systems, power can be provided throughout a 24-hour period, across seasons, and so on. Further, the solar systems can be used to charge and to rejuvenate battery cells within the battery system, and the batteries can be used to augment or replace power provided by the PV cells. Thus, the solar systems and the battery systems can provide power in many applications that require reliable and rechargeable energy sources.

Techniques for solar and battery systems integration are disclosed. A set of photovoltaic (PV) power sources is accessed. Each of the PV power sources includes a solar panel. The set of PV power sources is configured using one or more series connections. The series connections are used to obtain a desired maximum voltage from the set of solar panels. Each PV power source includes voltage sensing and current sensing. The sensing can be used to track power source output and condition. Bypassing is enabled for each PV power source within the set of PV power sources. The bypassing can be used to include or exclude a PV power source from one of the series configurations of PV power sources. The bypassing occurs at each PV power source, and the bypassing is performed by a distributed controller-switch at each PV power source. The distributed controller-switch includes a bypass switch, a series or selection switch, one or more sensors, and a control module. A battery management system is coupled to the set of PV power sources. Since the PV power sources can be elements within an integrated solar and battery system, the battery management system provides a configurable variable load voltage to the set of PV power sources. The load can include system loads such as charging batteries, rejuvenating batteries, and so on. The load can further include electrical loads receiving power from the PV power sources. The voltage and the current that are sensed at each PV power source of the set of PV power sources are monitored. The monitoring includes tracking PV power source operation, source health, etc. The bypassing of each PV power source and the variable load voltage of the battery management system are configured. The configuring enables PV power source power point tracking. The PV power source power point tracking is based on impedance matching. The impedance matching provides a local optimum power transfer operating point.

The number of PV power sources in the system can exceed the current requirements for a load. As a result, the current flow to the load can remain constant. Further, excess power from the PV power sources can be directed to the battery cells to recharge the cells. The recharging process can be repeated as needed, and whenever excess power is available from the PV power sources. A battery cell can also be rejuvenated as needed. The rejuvenation power can be provided by the PV power sources or by columns of batteries within the battery management system. The result is a safe and stable power source, recharging and managing itself. The battery management system is versatile, allowing for multiple battery systems and PV power sources to be linked to one another and controlled by redundant master controllers when needed. The battery management system can also be linked to an Industrial Internet of Things (IIoT) network, allowing reprogramming of the master controller and the use of dozens of different battery system arrangements of voltage, amperage, frequency, and duty cycle production, depending on the type of battery, the present health of the battery, the history of the battery, and so on.

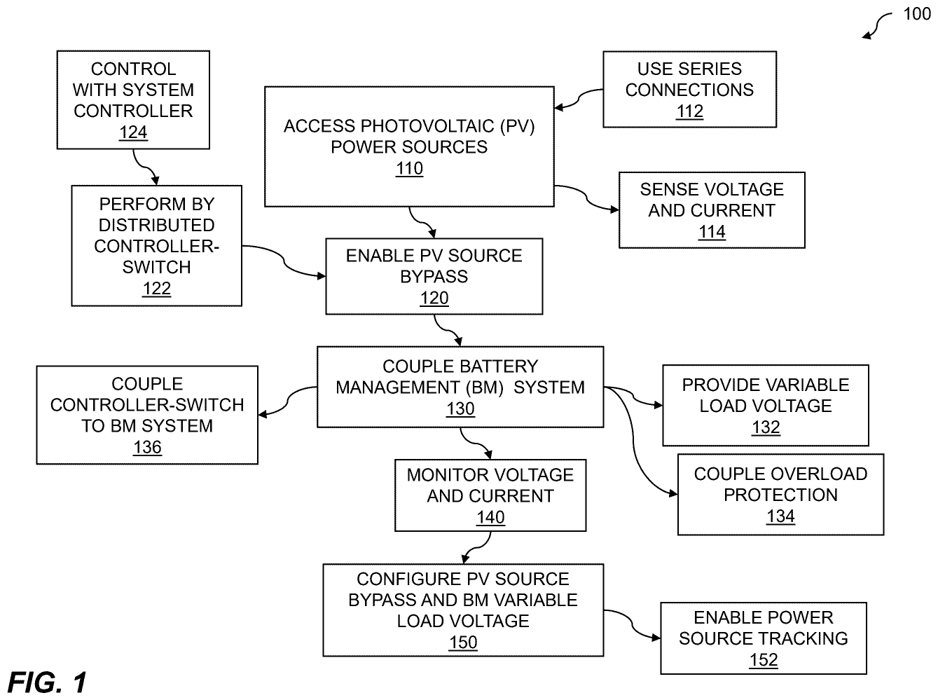

FIG. 1 is a flow diagram for integrated solar and battery systems with virtual power point tracking. The flow describes accessing a set of photovoltaic (PV) power sources. The PV power sources are configured by bypassing PV power sources. The bypassing is accomplished by a distributed controller-switch at each PV power source. The distributed controller-switches, which include a bypass switch, a series switch, one or more sensors, and a control module, can bypass a PV power source, select a PV power source, and monitor the PV power source using the one or more sensors. The distributed controller-switches are themselves controlled using a system controller. The system controller can activate and deactivate switches, collect sensor data, and so on. The system controller is integrated in a battery management system. The battery management system includes a group of rechargeable lithium battery units (BUs) configured with programmable switches. The switches are controlled by a master controller in the battery management system. The battery management system can be used to route power to a load, adjust load voltage and current, reconfigure the battery system for recharging, route a rejuvenation current to a battery cell or battery unit in need of rejuvenation, and so on. The battery management system further can control the PV power sources by configuring the bypassing of each PV power source of the plurality of PV power sources and the variable load voltage of the battery management system. The battery management system can route power from the PV power sources to recharge and rejuvenate the lithium battery units. The battery management system can supplement power from the PV power sources with power from the lithium battery units.

Sensors within each PV power source are used to monitor the health of each PV source. Sensors within each battery unit are similarly used to determine a health status of each battery cell. Performance data recorded by the sensors flows through local controller-switches to the system controller within the battery management system. The performance data can be updated based on timing controlled by the battery management system. The performance data can also be compared to predetermined configurations provided by external sources. When the battery management system determines that a PV power source or a battery cell is not performing to a specification, the battery management system configures programmable switches to deselect the PV power source or battery cell, to select an alternative PV power source or battery cell, etc. In some cases, multiple PV power sources and/or multiple battery systems can be linked together to provide additional capacity for handling power loads, for recharging or rejuvenating battery cells, and the like. The battery management system configures the programmable switches within PV power source distributed controller-switches or local battery controllers to direct PV generated power to recharge batteries, rejuvenate batteries, etc.

The flow 100 includes accessing 110 accessing a plurality of photovoltaic (PV) power sources. The photovoltaic power sources can be based on semiconductor elements that exhibit the photovoltaic effect. In embodiments, each of the plurality of PV power sources can include a solar panel. The solar panels can include panels manufactured by a single manufacturer or a variety of manufacturers. The plurality of solar panels can include panels with various capabilities such as output voltage and output current. The PV panels can include new panels, panels removed from previous service, refurbished panels, etc. In the flow 100, the plurality of PV power sources is configured 112 using one or more series connections. The series connections of the PV panels can be used to obtain voltage required by a system that includes the PV panels, by a load, and so on. In a usage example, the required voltage can range between 12V and 1000V. The PV power sources configured in series connections can further be configured using one or more parallel connections. The parallel configuration that can include two or more of the series connections of PV panels can be used to attain a required amperage. In a usage example, the required amperage can range between 30 A and 150 A. In the flow 100, each PV power source of the plurality of PV power sources includes voltage sensing and current sensing 114. The voltage sensing and the current sensing are accomplished using one or more voltage sensors and one or more current sensors respectively. Each PV power source can include other sensors. The sensors can further include temperature sensors, short-circuit sensors, impedance sensors, and the like. The sensors associated with each PV panel can accomplish monitoring of PV panel status or “health” over time. The monitoring can identify which panels are operating as expected, require maintenance or replacement, etc.

The flow 100 includes enabling the bypassing 120 of each PV power source of the plurality of PV power sources. The bypassing of a PV power source can be accomplished using a switch such as an electronically controlled switch. In a usage example, the electronically controlled switch can include an insulated-gate bipolar transistor. In embodiments, the bypassing can occur at each PV power source. The bypassing a PV power source can be used to bypass panels that are not needed to meet voltage or amperage requirements. The bypassing can bypass a failed panel, bypass a panel that requires maintenance, bypass a panel to enable replacement of the panel, and so on. Further bypassing can be used to bypass a series connection of PV panels. In the flow 100, the bypassing can be performed by a distributed controller-switch 122 at each PV power source. The distributed controller-switch can bypass a panel or select a panel. In embodiments, each distributed controller-switch can include a bypass switch, a series switch, one or more sensors, and a control module. A selected panel can be configured in a series with one or more other PV panels. The distributed controller-switch can select a PV panel for inclusion in a configuration of PV panels. Switches within the distributed controller-switch can be based on a variety of semiconductor technologies. In embodiments, the bypass switch and the series switch can include insulated-gate bipolar transistor switches.

The distributed controller-switches can be controlled by a master controller, a power management system, etc. The flow 100 can further include controlling each distributed controller-switch using a system controller 124. The system controller can include a standalone controller. The system controller can be an element of a management system. In embodiments, the system controller can be integrated in a battery management system (discussed below). The battery management system can be used to augment power provided by the PV panels with battery power, to direct power from the PV power sources to recharge batteries or to rejuvenate the batteries, etc. The battery management system can provide power when the PV panels are not producing power such as at night, are underproducing power, are offline, etc. In embodiments, the battery management system can control PV and battery power delivery to a load. The load can include electrical devices. The load can include batteries for storing excess power produced by the PV panels. The load can include rejuvenation of battery cells. In embodiments, the load can include a power grid. The power grid can include an onsite microgrid, a local grid, a regional grid, etc.

The flow 100 includes coupling a battery management system 130 to the plurality of PV power sources. The battery management system can include a plurality of battery cells, where the battery cells can be configured using one or more series connections. The series connections can be configured to obtain a maximum voltage, configured in parallel to obtain a maximum amperage, and so on. The battery management system can control charging battery cells, rejuvenating battery cells, bypassing or selecting battery cells, etc. In addition to configuring battery cells, the battery management system can configure the plurality of PV power sources via the system controller to the distributed controller-switches at each PV power source. In the flow 100, the battery management system provides a configurable variable load voltage 132 to the plurality of PV power sources. Discussed previously, the load voltage can be used to charge the batteries, supply power to a load, and so on. The batteries can supplement power delivery by the PV panels to a load. In embodiments, the battery management system can control PV and battery power delivery to a load. The load can include an electrically operated machine; a building such as a house, office building, hospital, or school; etc. The load can include a direct current (DC) load, an alternating current (AC) load, or both a DC load and an AC load. In embodiments, the battery management system can control power delivery to the load through an inverter. The inverter converts a DC voltage to an AC voltage. The magnitude of the AC voltage can be different from the magnitude of the DC voltage. The AC voltage can include a frequency such as a standard frequency, where the standard frequency can include 50 Hz, 60 Hz and so on.

The flow 100 further includes coupling overload protection devices 134 between the plurality of PV power sources and the battery management system. The overload protection can protect batteries from excessive charging due to excess power production by the PV power sources. The overload protection devices can protect battery cells from overheating, charging too quickly, etc. In embodiments, the overload protection devices prevent an overvoltage condition at the battery management system. The overvoltage condition could damage batteries, overheat batteries, and so on. In other embodiments, the overload protection devices prevent an overcurrent condition at the battery management system. The overcurrent condition could also damage battery cells by overheating them. The flow 100 further includes coupling 136 each distributed controller-switch to the battery management system. The coupling can be accomplished using wired techniques, wireless techniques, hybrid techniques, etc. In embodiments, the coupling enables system control of each distributed controller-switch. The controlling each distributed controller-switch can include activating or deactivating the bypass or the series switch, monitoring sensor data, and providing control signals to the control module.

The flow 100 further includes monitoring 140 the voltage and the current that are sensed at each PV power source of the plurality of PV power sources. The monitoring can be used to track the operation of a PV power source. The operation of the PV power source can include output voltage, output current, temperature, and so on. In embodiments, the one or more sensors can enable the monitoring. The monitoring can further track the health of the PV power source. The monitoring can enable the battery management system to provide voltage and current to one or more loads. The provided voltage and current can include a specified voltage, a specified current, a required frequency, etc. In embodiments, the control module can enable the configuring (discussed below). The control module can operate the bypass switch and the series switch, collect the sensor data, etc.

The flow 100 includes configuring 150 the bypassing of each PV power source of the plurality of PV power sources and the variable load voltage of the battery management system. The bypassing of a given PV power source can be accomplished using a bypass switch associated with the given PV power source. The configuring can further include selecting a PV power source. The selecting a given PV power source can be accomplished using a series switch associated with the given PV power source. The bypassing or the selecting of a PV power source uses the bypass switch or the series switch within the distributed controller-switch at the given PV power source. The controlling each distributed controller-switch is accomplished using the system controller. Recall that the system controller can be integrated in the battery management system. The battery management system can configure one or more series connections of the PV power sources to attain a desired voltage. Further, the battery management system can configure one or more parallel connections of series connections of the PV power sources. The series connections of the PV sources can be configured to achieve the desired voltage, and the parallel connections of the series of PV power sources can be configured to attain the desired amperage. In addition to configuring the PV power sources, the battery management system controls PV and battery power delivery to a load. In embodiments, the configuring further controls total voltage delivery for the plurality of PV power sources and the battery management system. The total voltage delivery can include a voltage range or tolerance, a current range or tolerance, a frequency range or tolerance, etc. In other embodiments, the bypassing can enable PV power source in situ repair. The PV power sources can be reconfigured so that the PV power source requiring repair is deselected and electrically isolated from other PV power sources. Thus, the isolated PV power source can be maintained, repaired, or replaced while the battery management system can remain operational.

In the flow 100, the configuring enables PV power source power point tracking 152. The power point tracking can include maximum power point tracking (MPPT). The MPPT can include techniques that can be applied to power sources such as PV power sources. The MPPT techniques enable a maximum power extraction from the PV power sources as the power output of the power sources changes over time. The power output can vary due to sunlight intensity, angle of incidence of sunlight onto the power source, ambient temperature, physical condition of the power source, and so on. Maximum power point tracking can be based on impedance matching between the power source and the power load. Further, the characteristics of a load that can be driven by the PV power sources can vary. In embodiments, the power point tracking can provide source current/load voltage impedance matching. The MPPT can be accomplished by presenting an optimal load to the PV power sources. The optimal load can be provided by a circuit. The output voltage, output current, and, when the output includes an AC output, output frequency can be adjusted to one or more of a required voltage, required output current, and output frequency. In embodiments, the impedance matching can provide a local optimum power transfer operating point. The local optimum power transfer operating point can be determined with relatively little computation and can be a “good enough” load. In embodiments, the total voltage delivery and the PV power source power point tracking are balanced against a power delivery metric. The power delivery metric can include contractual requirements for voltage and current provision. The contractual requirements can include specified voltages, currents, and frequencies; voltage, current, and frequency tolerances; an amount of time such as an amount of time to provide backup power, etc. In embodiments, the accessing, the enabling, the coupling, the monitoring, and the configuring can provide a solar management system. The solar management system can provide power, store excess power, etc. Recall that each distributed controller-switch associated with each PV source includes sensors such as voltage sensors and current sensors. In embodiments, the one or more sensors can enable the monitoring.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

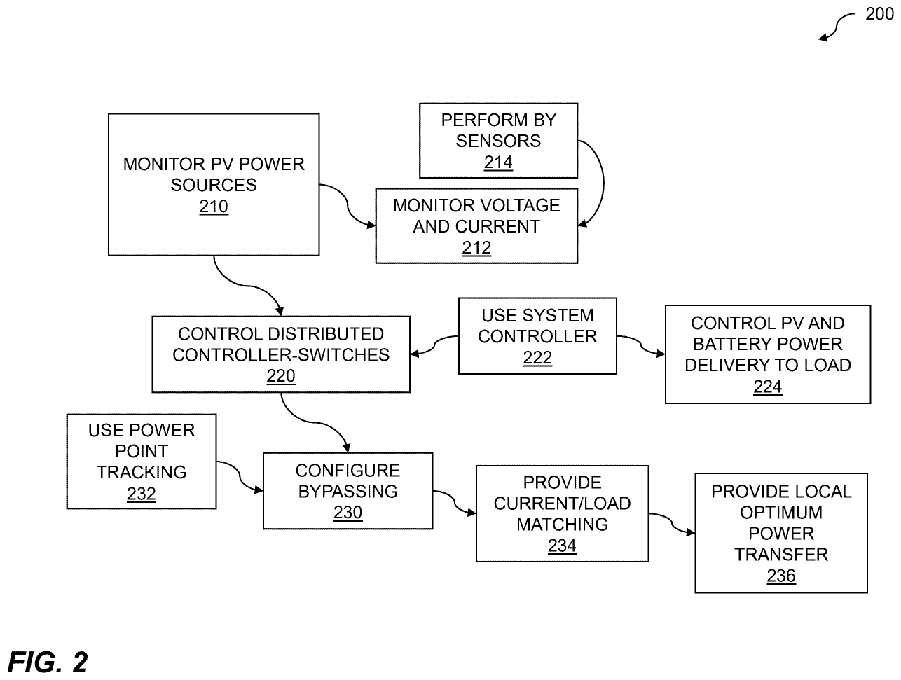

FIG. 2 is a flow diagram for a bypass configuration. Discussed previously, photovoltaic (PV) power sources can be configured to provide power to electrical loads. The electrical loads can include DC-to-DC converters, DC-to-AC inverters, battery cells, power grids, and so on. The PV power sources can be configured to achieve a desired voltage and/or desired current. The configuring the PV power sources can include series connections of PV panels, parallel connections of series connections of PV panels, and the like. The configuring can be accomplished by using a system controller to manipulate a distributed controller-switch at each PV power source. Each distributed controller-switch includes a bypass switch, a series switch, one or more sensors, and a control module. A distributed controller-switch can be used to bypass a PV power source or select the PV power source. Bypass configuration enables integrated solar and battery systems with virtual power point tracking. A plurality of photovoltaic (PV) power sources is accessed. The plurality of PV power sources is configured using one or more series connections. Each PV power source of the plurality of PV power sources includes voltage sensing and current sensing. Bypassing each PV power source of the plurality of PV power sources is enabled. The bypassing occurs at each PV power source, and the bypassing is performed by a distributed controller-switch at each PV power source. A battery management system is coupled to the plurality of PV power sources. The battery management system provides a configurable variable load voltage to the plurality of PV power sources. The voltage and the current are monitored. The voltage and the current are sensed at each PV power source of the plurality of PV power sources and are monitored. The bypassing of each PV power source of the plurality of PV power sources and the variable load voltage of the battery management system are configured. The configuring enables PV power source power point tracking.

The flow 200 includes monitoring 210 each PV power source of the plurality of PV power sources. The monitoring can include measuring and tracking a variety of parameters associated with each PV power source. In the flow 200, the monitoring can include monitoring voltage and current 212 at each PV power source. Other PV power source parameters can be measured, such as PV power source temperature, power source status (operating or not operating), etc. In the flow 200, the monitoring is accomplished using sensors 214. Discussed previously, each PV power source can include a distributed controller-switch. In embodiments, each distributed controller-switch can include a bypass switch, a series switch, one or more sensors, and a control module. The one or more sensors can include a voltage sensor and a current sensor included in each PV power source.

The flow 200 includes controlling 220 each distributed controller-switch. The controlling of each distributed controller-switch at each PV power source can include bypassing a PV power source, selecting the PV power source, and monitoring sensor data. The flow 200 further includes controlling each distributed controller-switch using a system controller 222. The system controller can bypass or select a PV power source based on power load requirements, on the monitored sensor data, and so on. The system controller can include a standalone system controller for PV power sources. In embodiments, the system controller can be integrated in a battery management system. The battery management system can control battery cells, where the battery cells can be used to provide power, to store excess power from the PV power sources, etc. The battery management system can manage power delivery. In the flow 200, the battery management system controls PV and battery power delivery 224 to a load. The power delivery can be accomplished using batteries, PV power sources, or a combination of batteries and PV power sources. The power that is delivered can include DC power, AC power, and a combination of DC power and AC power. The DC power can be provided to a load that requires a different DC voltage than the voltage produced by the batteries of the PV power sources. The different DC voltage can result from converting DC power output by the PV power sources and the battery sources using a DC-to-DC converter. AC power provided by the battery management system can use an inverter to convert DC power to AC power.

The flow 200 includes configuring the bypassing 230 of each PV power source of the plurality of PV power sources and the variable load voltage of the battery management system. The system controller within the battery management system can configure the bypassing by controlling the bypass switch and the series switch in each distributed controller-switch at each PV power source. The configuring can include activating or deactivating a semiconductor switch such as an insulated-gate bipolar transistor (IGBT) switch. In the flow 200, the configuring is accomplished using PV power source power point tracking 232. The power point tracking can track power output from the PV power sources and/or batteries. The power point tracking can further track an impedance of a power load, where the impedance can be dynamic. In the flow 200, the power point tracking can provide source current/load voltage impedance matching 234. Maximum power transfer between the power sources and the load can be accomplished by matching the impedance of the load to the impedance of the power sources. The impedance matching can be accomplished using an impedance matching element. In the flow 200, the impedance matching can provide an optimum power transfer operating point 236. The impedance matching can further provide a local optimum power transfer operating point. The providing a local optimum power transfer operating point can be used to quickly respond to dynamic changes in load impedance.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

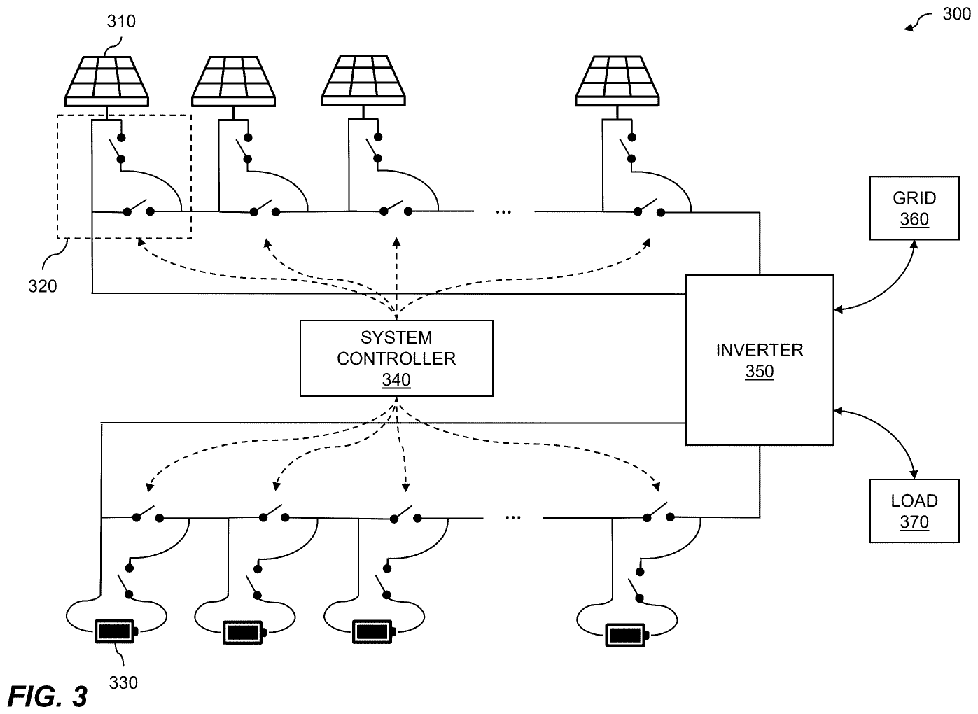

FIG. 3 is a block diagram for a distributed control and management system for direct current (DC) systems. Discussed previously and throughout, a distributed power system can be based on direct current (DC) power management. The distributed power system can include a plurality of power sources, where the power sources can include photovoltaic (PV) solar panels, batteries, and so on. Connections of solar panels and connections of batteries can be used independently or together to provide DC power. The DC power can be converted to alternating current (AC) power using one or more inverters. The one or more inverters can provide power to AC loads, power back into an electrical grid, and so on. DC power management integrates solar and battery systems with virtual power point tracking. A plurality of photovoltaic (PV) power sources is accessed. The plurality of PV power sources is configured using one or more series connections. Each PV power source of the plurality of PV power sources includes voltage sensing and current sensing. Bypassing each PV power source of the plurality of PV power sources is enabled. The bypassing occurs at each PV power source, and the bypassing is performed by a distributed controller-switch at each PV power source. A battery management system is coupled to the plurality of PV power sources. The battery management system provides a configurable variable load voltage to the plurality of PV power sources. The voltage and the current are monitored. The voltage and the current sensed at each PV power source of the plurality of PV power sources are monitored. The bypassing of each PV power source of the plurality of PV power sources and the variable load voltage of the battery management system are configured. The configuring enables PV power source power point tracking. The configuring that is computed can be based on load requirements, grid requirements, regulatory requirements, service level agreement (SLA) requirements, configuration requirements, system profile requirements, system reliability requirements, and so on.

The block diagram 300 can include one or more power sources 310 such as photovoltaic solar panels. The solar panels can include new panels, salvaged or repurposed panels, and so on. The solar panels can include substantially similar panels or can include a diversity of solar panels. The one or more solar panels can be configured using a series connection. The series connection can be used to configure the solar panels to attain a required or target voltage, current, shape factor, and the like. The block diagram 300 can include one or more distributed controller-switches 320. A distributed controller-switch can include a variety of components. In embodiments, the distributed controller-switch can include a bypass switch, a series or selection switch, one or more sensors, and a communications module coupled to the system controller. The shunt or bypass switch can be used to bypass a DC power source. The DC power source can be bypassed due to source failure, routine maintenance, source replacement, and the like. The series switch can include a switch coupled to terminals associated with the DC power source. The terminals can include an anode terminal and a cathode terminal, connectors associated with the power source, etc. The one or more sensors can include voltage and current sensors, resistivity sensors for short circuit or open circuit detection, thermal sensors, damage or leakage sensors, and so on. The communications module can enable communications between the one or more distributed controller-switches and a system controller (discussed below). The communications can be based on communications standards associated with wired, wireless, and hybrid wired-wireless communications standards.

The block diagram 300 can include one or more additional power sources 330. The additional power sources can include batteries, as shown, capacitors, and other electrical energy storage components. The additional power sources can be configured using a series connection. Each of the additional power sources can be coupled to a distributed controller-switch. The additional one or more distributed controller-switches can be substantially similar to the distributed controller-switches associated with the photovoltaic solar panels described previously. In embodiments, the additional power sources and the power sources can be configured using a parallel connection. That is, the series connection of solar panels and the series connection of batteries or other DC power sources can be configured in parallel. In other embodiments, the additional power source and the power sources can be configured using a series connection. Each DC power source, such as power sources 310 and 330 can actually be comprised of a string of DC power sources, typically connected in series. The string of DC power sources can comprise homogeneous power sources or heterogeneous power sources.

The block diagram 300 can include a system controller 340. The system controller can be coupled to each of the distributed controller-switches associated with the DC power sources such as solar panels, and each of the distributed controller-switches associated with the additional DC power sources such as the batteries. The system controller can control each distributed controller-switch by actuating the bypass switch and the series switch. In embodiments, the system controller can monitor each distributed controller-switch. The monitoring can include detecting the state of the bypass switch and the series switch, collecting sensor data, communicating with the communications module, and so on. The sensor data that can be collected can include resistivity data which can be analyzed to detect low resistance, such as a short circuit, and high resistance, such as an open circuit. The sensor data can include temperature data. The temperature data can be analyzed to determine a normal temperature, high temperature, or critical temperature. The sensor data can further include battery status data such as present or missing; physical shock which could occur due to a drop, tampering or vandalism; etc. The sensor data can include power source voltage and current, among other sensor data categories.

The system controller can be coupled to a computing device. The computing device can include a smartphone, tablet, laptop computer, desktop computer, server, remote server, and so on. The computing device can include a purpose-built computing device for DC power management and control. In embodiments, the computing device can be used to compute an optimal DC power source configuration, based on the monitoring. The DC power source configuration can be used to configure the DC power system, reconfigure the DC power system, etc. The DC power source optimization can be based on a variety of criteria. In embodiments, the reconfiguring can enable a level voltage at output terminals of the series connection. The level voltage can include a voltage designed for power loads, a voltage for an inverter, and so on. In embodiments, the reconfiguring can enable a level current at output terminals of the series connection. As for the voltage, the level current can be designed for loads, inverters, and the like. In embodiments, the level current can be chosen to enable charging of various types of batteries. In other embodiments, the reconfiguring can enable hot swapping of one or more of the plurality of DC power sources. The hot swapping can support removal and replacement of DC power sources such as PV solar panels, batteries, capacitors, etc. without having to shut down the DC power system. In further embodiments, the computing and the reconfiguring can enable meeting a DC power source reliability metric. The reliability metric can include a voltage or current tolerance, a mean time to failure (MTTF) value, etc.

The block diagram 300 can include an inverter 350. The inverter can include a power conversion device that can convert DC power from the DC power sources to another DC voltage/current point (DC-to-DC converter), or an inverter that can invert the DC power sources to an AC voltage/current point (DC-to-AC inverter). An inverter can be coupled to the DC power system in order to convert the DC power to AC power. The AC power can include a standard voltage such as 120V or 240V, a standard frequency such as 60 Hz, and so on. An inverter can invert DC power provided by the PV solar panels, the batteries, and other DC power sources. The power conversion device can provide AC and/or DC power via reverse or “net” metering to an electrical grid such as grid 360. The grid can include a microgrid, a local grid, a regional grid, etc. The power conversion device can further provide AC and/or DC power to one or more loads 370. The loads can include various types of lights; electrical equipment; heating, cooling, and air conditioning (HVAC) systems; water and filtration systems; and the like. The AC power provided by the inverter can be used to supplement the AC power provided by the electrical grid. The AC power provided by the inverter can be used as backup power, replacement power, etc.

In embodiments, a system controller can manage controlled replacement of DC power sources such as photovoltaic (PC) solar panels, batteries, and so on. The system controller can be used to control a DC power system. The DC power system can comprise a plurality of PV solar panels, batteries, capacitors, and the like. The DC power system can access distributed controller-switches, where a distributed controller-switch is coupled to each DC power source. The distributed controller-switch can include a bypass switch, a series switch, one or more sensors, and a communications module coupled to the system controller. The distributed controller-switch associated with each DC power source can monitor sensors associated with the power source; send messages to the system controller; respond to commands, requests, etc. sent by the system controller; and so on. The distributed controller-switch can sense DC power source performance characteristics. The distributed controller-switch can process integrated button presses, actuate an electro-mechanical interlock component, etc., under control of the system controller. The distributed controller-switch can communicate an event to the system controller, such as a button press event, using a signal communication path accessible via the communications module. The button press event can indicate a DC power source to be replaced. The signal communication path can be based on one or more communications standards, protocols, etc. The system controller can communicate with devices, systems, and so on beyond the DC power system. In embodiments, the communications beyond the DC power system can be enabled by an Industrial Internet of Things (IIoT) protocol. A management system can determine the DC power system configuration based on power requests to the system. The requests can be made by a user or automatically by a system requiring energy coupled to the DC power system. The management system can configure the DC power system by determining how to direct the switches such as software-controlled switches to couple specific DC power sources to achieve the desired configuration. The management system can further provide DC power system status information using protocols such as secure TCP/IP protocols.

The system controller can effect in situ DC power source configuration, reconfiguration, and so on. In embodiments, the in situ DC power source reconfiguration can enable real-time power capability adjustment for the plurality of DC power sources. The real-time power capability adjustment can be based on periodic sampling of DC power system capability, load requirements, and so on. In embodiments, the real-time power capability adjustment can provide matching between DC power source performance and DC power management system load requirements. The system controller can control adding a DC power source to a DC power system, removing a DC power source, replacing a DC power source, etc. In embodiments, the system controller can enable a DC power source hot swap operation. The system controller can further operate physical retainment of DC power sources associated with a DC power system. Further embodiments can include electromechanically interlocking each DC power source of the plurality of DC power sources as part of the configuring. The electromechanical interlock is controlled by the system controller.

The system controller can communicate with a communications device. The communications device can be remote from the system controller and can be employed by a user to communicate with the DC power system. The communications device can comprise a computer, laptop, tablet, cellphone, PDA, and the like. In embodiments, the communications device is another DC power system, power grid, charging station, etc. which can negotiate power requirements directly with the DC power system. Communication between the communications device and the system controller can be accomplished using a variety of electronic communication techniques. The communication can be accomplished over an industrial grade hardware interface such as CAN, RS485, Modbus, etc. In embodiments, the system controller enables an Industrial Internet of Things (IIoT) capability for the DC power system to enable business-to-business communications over the Internet.

Other communications protocols can be supported. The system can support protocols such as Simple Object Access Protocol (SOAP), Representational State Transfer (REST), and so on. The system controller can support queries from the communications device to the DC power system. For example, the system controller can support a query to supply system information. The system information can include DC power source profiles; system status; temperature, current, voltage, and power cycle information; and so on. The system controller can provide information based on a query of capabilities of the DC power system. The capabilities can include features, number, and health of DC power sources; voltage output range; power capacity of the DC power system; total energy; carbon footprint calculation; and so on. The system controller can also provide information based on a query on availability of output from the DC power system. An availability of output query can include information on the readiness of the system, charging time required, time until a charge is needed, and so on. In cases where one of the DC power sources in the DC power system fails, has degraded performance characteristics, represents a safety risk, etc., the system controller can decommission a DC power source. The decommissioning can disable one or more DC power sources in the system. The system controller can include the ability for a user or system to provide power request parameters to the DC power system. The power request parameters can include voltage, power, total energy, external system operating requirements, internal system operating requirements, user settings, or user preferences.

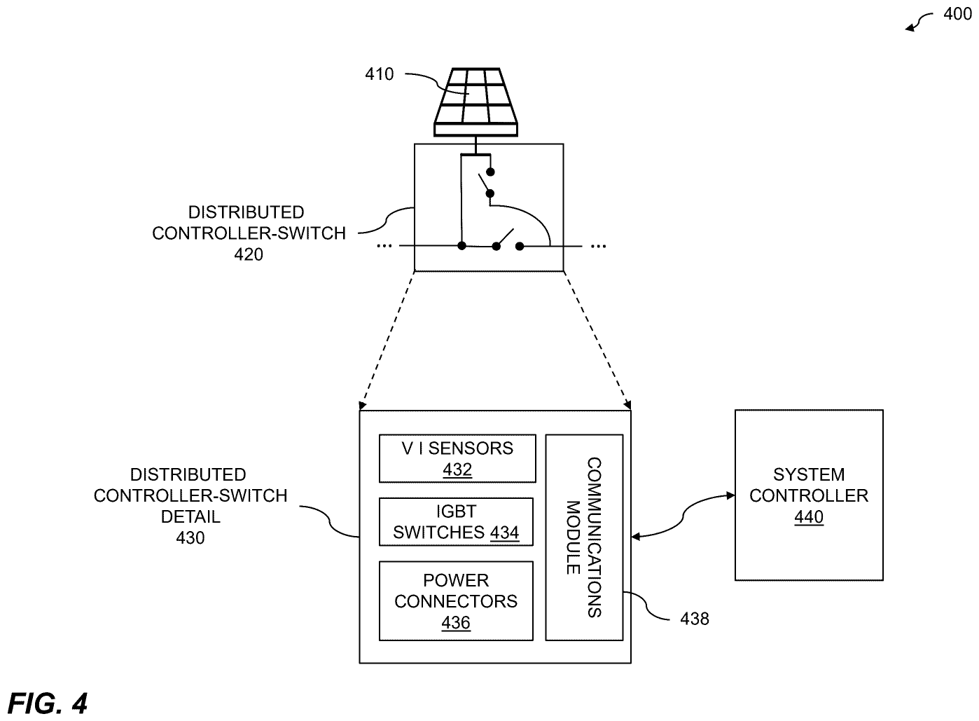

FIG. 4 is a block diagram of a distributed controller. Discussed previously and throughout, a distributed controller-switch can be used to bypass a connection of DC power sources. The distributed controller-switch can provide data such as voltage and current data associated with a DC power source to a system controller, which can monitor the data. The system controller can determine an optimal DC power source configuration, where the optimal DC power source configuration can provide a target voltage or current, can meet DC power system requirements for power loads and reliability, and so on. The distributed controller-switch enables integrated solar and battery systems with virtual power point tracking. A plurality of photovoltaic (PV) power sources is accessed. The PV power sources is configured using one or more series connections. Each PV power source includes voltage sensing and current sensing. Bypassing is enabled for each PV power source. The bypassing occurs at each PV power source, and the bypassing is performed by a distributed controller-switch at each PV power source. A battery management system is coupled to the PV power sources. The battery management system provides a configurable variable load voltage to the plurality of PV power sources. The voltage and the current that are sensed are monitored as each PV power source is sensed. The bypassing of each PV power source and the variable load voltage of the battery management system are configured. The configuring enables PV power source power point tracking.

The block diagram includes a photovoltaic (PV) solar panel 410. The PV panel can be one of a plurality of DC power sources for use within a DC power system. The one or more PV panels can be configured using a series connection of the panels. A distributed controller-switch 420 is coupled to the solar panel. The distributed controller-switch includes switches, sensors, a communications module, and so on. A detailed view of the distributed-controller-switch is shown 430. The distributed controller-switch includes one or more sensors 432. The sensors include one or more voltage sensors and a current sensor and can include additional sensors, such as a resistivity sensor, a thermal sensor, and so on. The one or more sensors can include one or more of a vibration or impact sensor, a leakage sensor, a tamper sensor, and the like. The distributed controller-switch can include a bypass or shunt switch and a series or selection switch. The bypass switch can be used as a bypass or shunt switch, to bypass the panel. The panel can require bypassing for maintenance, replacement, etc. The shunt switch can be used to electrically isolate or disconnect the PV panel from the series connection of PV panels. The series or selection switch can be used to select the PV panel for inclusion in a series configuration of PV sources. The bypass switch and the series switch can be implemented based on a variety of semiconductor technologies. In the block diagram 400, the bypass switch and the series switch can include insulated-gate bipolar transistor (IGBT) switches 434. The IGBT devices can be operated simply and are voltage-controlled devices.

The block diagram 400 can include power connectors 436. The power connectors can enable a PV panel to be configured with other PV panels using a series connection. The power connectors can include power connectors to the PV panel, power connectors controlled by the distributed controller-switch, and so on. The power connectors can include industry standard power connectors. In the block diagram, the distributed controller-switch can include a communications module 438. The communications module can enable communications between the distributed controller-switch and a system controller 440. In embodiments, the communication can be based on one or more communication techniques such as wired techniques, wireless techniques, fiber-based techniques, and so on. The wired technology can include coaxial, twisted pair, etc. The wired technology can support one or more wired communications protocols such as USB, RS-232, RS-485, and the like. The communications standards used for coupling the distributed controller-switch to the system controller can further include Ethernet™, Ethernet/IP™, and EtherCAT™; fiber distributed data interface (FDDI), fiber channel, asynchronous transfer mode (ATM), etc. The communication techniques can include, 802.11, Zigbee™, near-field communication (NFC), and so on. The communications standards can further include Industrial Internet of Things (Industrial IoT, IIoT).

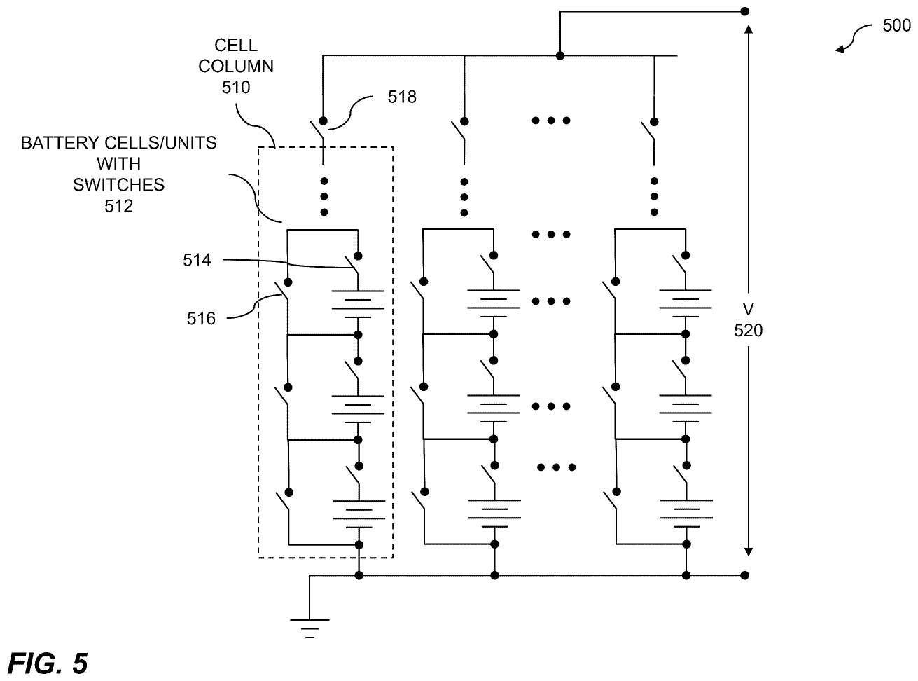

FIG. 5 is an infographic showing columns for battery cells and switches in a battery system. The infographic 500 includes a plurality of battery cells that can be configured within the battery system using the switches. In embodiments, the one or more battery cells are comprised of lithium cells. The lithium batteries can include other types of rechargeable lithium-type cells such as lithium-ion battery cells, lithium-polymer (LiPo) cells, lithium-iron-phosphate (LiFePO4) cells, and so on. The battery cells can include new rechargeable batteries and used rechargeable batteries. The battery cells can include rechargeable batteries that have been removed from vehicles, energy storage devices, personal electronic devices, and so on. These recovered batteries can be considered used, previously used, preowned, “second life,” etc. New and used battery cells can be combined within the battery units. The battery cells can be arranged in series using the programmable switches. The programmable switches can be used to combine battery cells into battery units. The programmable switches and the battery cells can support integrated solar and battery systems with virtual power point tracking.

The battery system can include one or more cell columns such as cell column 510. A cell column includes a plurality of battery cells and/or battery units and a plurality of programmable switches. The plurality of battery units (and/or cells) can be configured using the plurality of programmable switches. The programmable switches can include a bypass switch 514 and a series switch 516. The programmable switches are repeated for each battery unit 512 (or cell) that comprises battery column 510. Each battery column can be connected in parallel using the programmable switches. Each column of battery units can be isolated using one or more programmable switches, such as switch 518. The infographic 500 shows all programmable switches open. More battery cells could be configured into each battery column. More battery columns could be added to the battery system. In the infographic 500, all battery cells, units, and columns are isolated and are not supplying power to a load, being recharged, or being rejuvenated.

The plurality of battery cells can be configured by a master controller (not shown). The voltage, the amperage, the frequency, the duty cycle, and the duration of each battery cell and battery column can be supervised by the master controller. The voltage can comprise a maximum voltage between 3V and 1000V. The amperage can comprise a maximum amperage between 30 A and 150 A. The frequency can comprise a maximum frequency between 0.5 Hz and 500 Hz. The duty cycle can comprise an on percentage between 30% and 70%. The duration can comprise a time between 1 s and 100 s. The master controller can configure the programmable switches to provide the required voltage 520 across the battery system so that the current supplied to the load does not sag or surge. The master controller can use battery columns within the battery system to recharge and rejuvenate in situ battery cells as needed in order to maintain the required voltage across the battery system.

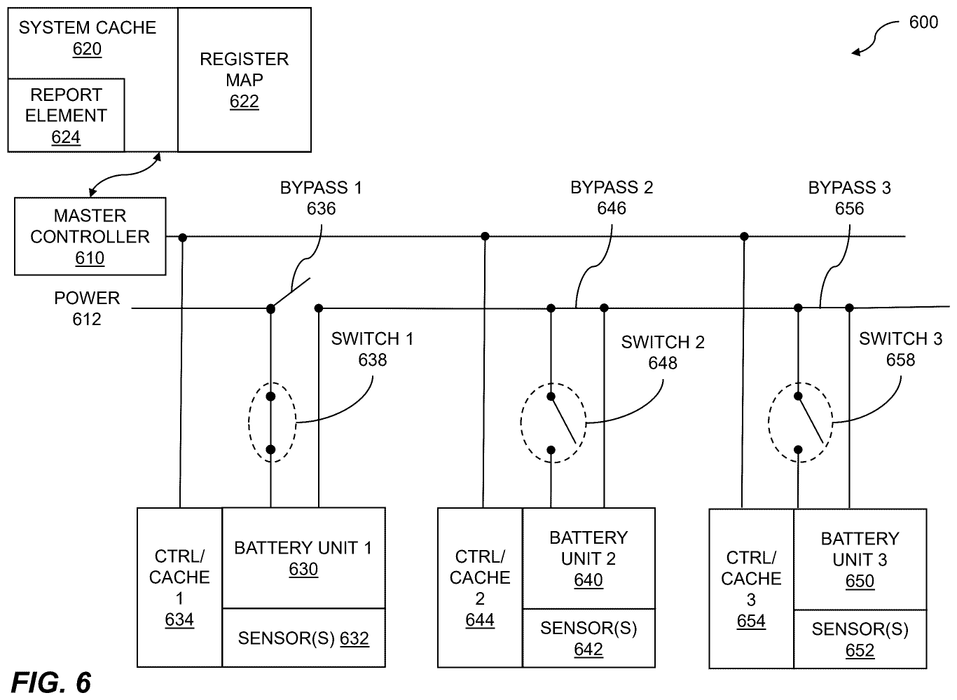

FIG. 6 is a system block diagram for a battery management system with in situ cell rejuvenation. Rechargeable batteries can lose storage capacity over time thereby reducing capacity of a system such as an integrated solar and battery system in which the rechargeable batteries are used. The loss of storage capacity and power delivery can result from battery age, operating temperature, battery charging techniques, usage history, and so on. A battery can be reconditioned in order to return some or all of the charge storage and provision capacity to the battery. The rejuvenation of the battery cell can include charging the battery at a controlled voltage value and a controlled current value. The rejuvenation of the battery can include a conditioning charge, a controlled discharge, a full charging of the battery, testing, and so on. The rejuvenation of the battery can be accomplished in situ. The in situ cell rejuvenation supports an integrated solar and battery system with virtual power point tracking. A plurality of photovoltaic (PV) power sources is accessed. The plurality of PV power sources is configured using one or more series connections, and each PV power source of the plurality of PV power sources includes voltage sensing and current sensing. Bypassing of each PV power source of the plurality of PV power sources is enabled, where the bypassing occurs at each PV power source. The bypassing is performed by a distributed controller-switch at each PV power source. A battery management system is coupled system to the plurality of PV power sources. The battery management system provides a configurable variable load voltage to the plurality of PV power sources. The voltage and the current are monitored. The voltage and the current are sensed at each PV power source of the plurality of PV power sources. The bypassing of each PV power source of the plurality of PV power sources and the variable load voltage of the battery management system are configured. The configuring enables PV power source power point tracking.

The block diagram 600 includes a master controller 610. In embodiments, the plurality of battery units is configured by the master controller. The configuration of the battery units can be accomplished by programmable switches managed by the master controller. In embodiments, the voltage, the amperage, the frequency, the duty cycle, and the duration are supervised by the master controller. Battery performance data can be sent to a system cache 620 included in the master controller. The battery performance data can be compared to battery performance standards stored in one or more register maps 622. The master controller can access one or more predetermined configurations for battery cells, battery units, and battery columns. The in situ performance measurements from the battery units can be compared to the performance standards to determine which battery units require rejuvenating. The master controller can analyze battery units to determine usability and capacity of the battery units. The master controller can include a report element 624. The report element can communicate with battery system operators and/or systems included in an IIoT network. The report element can include information on battery cell performance, battery cells needing removal or replacement, electrical statistics, rates of discharge, and so on.

The block diagram 600 includes a plurality of battery units. In embodiments, the battery units contain one or more battery cells. The battery cells can include new rechargeable batteries and used rechargeable batteries. New and used battery cells can be combined in the battery units. In embodiments, the one or more battery cells are comprised of lithium, including lithium-ion battery cells. Other types of rechargeable cells, such as lithium-polymer (LiPo) cells, and lithium-iron-phosphate (LiFePO4) cells, can be included. The battery units included in the diagram are battery unit 1 630, battery unit 2 640, and battery unit 3 650. Additional battery units can be included in battery system arrangements not shown in this diagram. Each battery unit can include one or more sensors. The one or more sensors can monitor the cell voltage, cell amperage, cell frequency, etc. of the battery unit. The sensors included in the diagram are sensor 632 for battery unit 1, sensor 642 for battery unit 2, and sensor 652 for battery unit 3. Each battery unit can include one or more controller caches, which can be used to store sensor data and to forward the data to the master controller. The controller caches included in the diagram are ctrl/cache 1 634 for battery unit 1, ctrl/cache 2 644 for battery unit 2, and ctrl/cache 3 654 for battery unit 3. The battery performance data collected by the sensors can be forwarded to the master controller based on a system clock managed by the master controller, by tokens, by packets, by carrier sense multiple access (CSMA), and so on.

In embodiments, the plurality of battery units is configured with programmable switches. In the block diagram 600, two sets of switches are shown for each battery unit. A bypass switch is included in the power flow circuit to each battery unit. The power flow circuit can include a rejuvenation current. The bypass switch allows power 612 to flow to a load without flowing through a battery unit. The rejuvenation current can be provided by additional battery units within the battery system. The rejuvenation current can also be provided by one or more additional battery systems connected to the battery system shown in the diagram. In the block diagram 600, bypass switch 1 636 is shown in the open position. When combined with closed switch 1 638, a rejuvenation current will pass into battery unit 1. Bypass switch 2 646 and bypass switch 3 656 are shown in the closed position. When combined with open switch 2 648 and open switch 3 658, respectively, a rejuvenation current cannot enter battery unit 2 or battery unit 3.

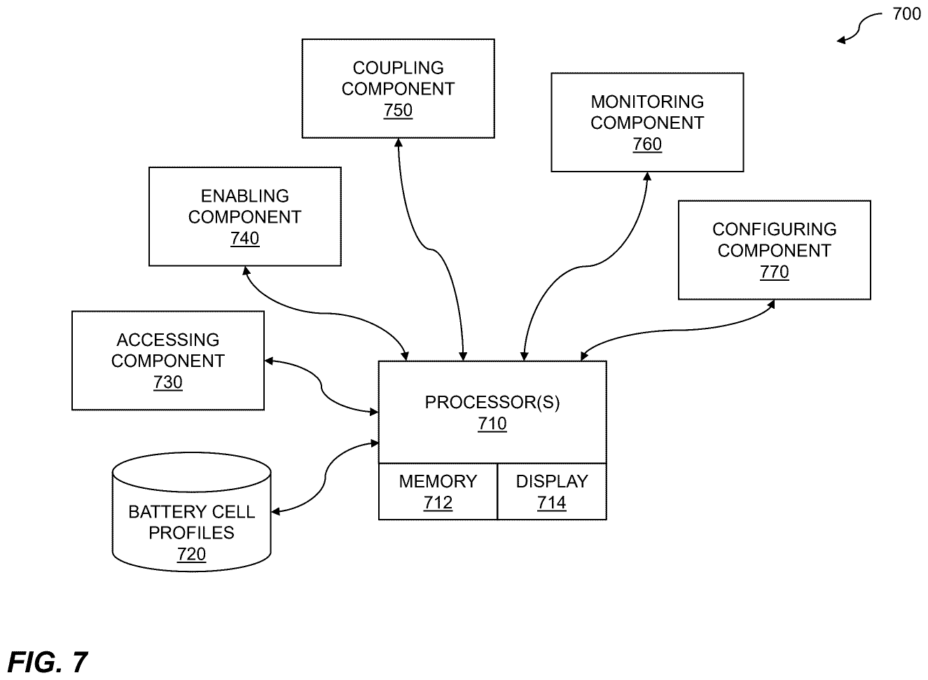

FIG. 7 is a system diagram for solar and battery systems. The solar and battery systems include an integrated solar and battery system with virtual power tracking. The system 700 can include one or more processors 710 coupled to a memory 712 which stores instructions. The system 700 can include a display 714 coupled to the one or more processors 710 for displaying data, intermediate steps, instructions, and so on. The data can further include sensor data, configuration information, power point tracking data, and the like. In embodiments, one or more processors 710 are coupled to the memory 712 where the one or more processors, when executing the instructions which are stored, are configured to: access a plurality of photovoltaic (PV) power sources, wherein the plurality of PV power sources is configured using one or more series connections, and wherein each PV power source of the plurality of PV power sources includes voltage sensing and current sensing; enable bypassing each PV power source of the plurality of PV power sources, wherein the bypassing occurs at each PV power source, and wherein the bypassing is performed by a distributed controller-switch at each PV power source; couple a battery management system to the plurality of PV power sources, wherein the battery management system provides a configurable variable load voltage to the plurality of PV power sources; monitor the voltage and the current that are sensed at each PV power source of the plurality of PV power sources; and configure the bypassing of each PV power source of the plurality of PV power sources and the variable load voltage of the battery management system, wherein the configuring enables PV power source power point tracking.

The system 700 includes battery cell profiles 720. The battery cell profiles 720 can include a battery type, battery manufacturing lot data, battery age, battery usage, battery charge/discharge cycles, battery quality indications, battery charging requirements, battery rejuvenation requirements, and so on. The battery cell profiles 720 can be updated over time based on battery monitoring, battery manufacturing lot data updates, etc. The battery cell profiles can be used by the master controller to determine when a battery cell requires rejuvenation and to provide parameters for the rejuvenating process. The battery cell profiles can further be used to predict battery cell mean time to failure (MTTF). The battery cell profiles can be used to mark battery cells for replacement. The system can further include photovoltaic (PV) power source profiles (not shown). The PV power source profiles can include PV panel manufacturer, panel manufacturing data such as panel lot data, panel age, panel performance data, etc. The PV panel profiles can be updated over time based on data such as usage data and performance data. The PV panel profiles can be used by the master controller to monitor panel health, to recommend panel cleaning, to mark a panel for replacement, and the like.

The system 700 includes an accessing component 730. The accessing component 730 can include functions and instructions for accessing a plurality of photovoltaic (PV) power sources. In embodiments, each of the plurality of PV power sources can include a solar panel. The PV panels can include panels manufactured by a single manufacturer or a variety of manufacturers. The PV panels can include new panels, panels removed from previous service, refurbished panels, and so on. In embodiments, the plurality of PV power sources can be configured using one or more series connections. The series connections of the PV panels can be used to attain a required voltage. In a usage example, the require voltage can range between 12V and 1000V. The PV power sources configured in series connections can further be configured using one or more parallel connections. The parallel connections of the series connections of PV panels can be used to attain a required amperage. In a usage example, the required amperage can range between 30 A and 150 A. In embodiments, each PV power source of the plurality of PV power sources can include voltage sensing and current sensing. The voltage sensing and the current sensing are accomplished using one or more voltage sensors and one or more current sensors respectively. The sensors can further include temperature sensors, short-circuit sensors, and the like. The sensors associated with each PV panel can accomplish monitoring of PV panel health.

The system 700 includes an enabling component 740. The enabling component 740 can include functions and instructions for enabling the bypassing of each PV power source of the plurality of PV power sources. The bypassing of a PV power source can be accomplished using a switch such as an electronically controlled switch. In a usage example, the electronically controlled switch can include an insulated-gate bipolar transistor. The bypassing a PV power source can be used to bypass panels that are unneeded to meet voltage of amperage requirements. The bypassing can be used to bypass a failed panel, bypass a panel that requires maintenance, bypass a panel to enable replacement of the panel, and so on. In embodiments, the bypassing can occur at each PV power source. Further bypassing can be used to bypass a series connection of PV panels. In embodiments, the bypassing can be performed by a distributed controller-switch at each PV power source. The distributed controller-switch can bypass a panel or select a panel. In embodiments, each distributed controller-switch can include a bypass switch, a series switch, one or more sensors, and a control module. A selected panel can be configured in a series with one or more other PV panels. The distributed controller-switch can select a PV panel for inclusion in a configuration of PV panels. The distributed controller-switches can be controlled by a master controller, a power management system, etc. Further embodiments can include controlling each distributed controller-switch using a system controller. The system controller can include a standalone controller. The system controller can be an element of a management system. In embodiments, the system controller can be integrated in a battery management system. The battery management system can be used to augment power provided by the PV panels with battery power. The battery management system can provide power when the PV panels are not producing power such as at night, are underproducing power, are offline, etc. In embodiments, the battery management system can control PV and battery power delivery to a load. The load can include electrical devices. The load can include batteries for storing excess power produced by the PV panels. The load can include rejuvenation of battery cells. In embodiments, the load can include a power grid. The power grid can include an onsite microgrid, a local grid, a regional grid, etc.

The system 700 includes a coupling component 750. The coupling component 750 can include functions and instructions for coupling a battery management system to the plurality of PV power sources. The battery management system can include a plurality of battery cells, where the battery cells can be configured using one or more series connections. The series connections can be configured to attain a maximum voltage, configured in parallel to attain a maximum amperage, and so on. The battery management system can control charging battery cells, rejuvenating battery cells, bypassing or selecting battery cells, etc. In embodiments, the battery management system provides a configurable variable load voltage to the plurality of PV power sources. Discussed previously, the load voltage can be used to charge the batteries. The batteries can supplement power production by the PV panels. In embodiments, the battery management system can control PV and battery power delivery to a load. The load can include an electrically operated machine; a building such as a house, office building, hospital, or school; etc. The load can include a direct current (DC) load, an alternating current (AC) load, or both a DC load and an AC load. In embodiments, the battery management system can control power delivery to the load through an inverter. The inverter converts a DC voltage to an AC voltage. The magnitude of the AC voltage can be different from the magnitude of the DC voltage. The AC voltage can be delivered with a frequency such as a standard frequency. The standard frequency can include 50 Hz, 60 Hz and so on. Further embodiments can include coupling overload protection devices between the plurality of PV power sources and the battery management system. The overload protection can protect batteries from excessive charging due to excess power conditions, can protect battery cells from overheating, etc. In embodiments, the overload protection devices prevent an overvoltage condition at the battery management system. The overvoltage condition could damage batteries, overhead batteries, and so on. In other embodiments, the overload protection devices prevent an overcurrent condition at the battery management system. The overcurrent condition could also damage battery cells.

The system 700 includes a monitoring component 760. The monitoring component 760 can include functions and instructions for monitoring the voltage and the current that is sensed at each PV power source of the plurality of PV power sources. The monitoring can be used to track the operation of a PV power source, the health of the PV power source, and so on. The monitoring can enable the battery management system to provide specified, stable voltage and current to one or more loads. In embodiments, the accessing, the enabling, the coupling, the monitoring, and the configuring can provide a solar management system. The solar management system can provide power, store excess power, etc. Recall that each distributed controller-switch associated with each PV source includes sensors such as voltage sensors and current sensors. In embodiments, the one or more sensors can enable the monitoring.

The system 700 includes a configuring component 770. The configuring component 770 can include functions and instructions configuring the bypassing of each PV power source of the plurality of PV power sources and the variable load voltage of the battery management system. The bypassing of a given PV power source can be accomplished using a bypass switch associated with the given PV power source. The configuring can further include selecting a PV power source. The selecting a given PV power source can be accomplished using a series switch associated with the given PV power source. The bypassing or the selecting of a PV power source uses the bypass switch or the series switch within the distributed controller-switch at the given PV power source. The controlling each distributed controller-switch is accomplished using a system controller. Recall that the system controller can be integrated in the battery management system. The battery management system can configure one or more series connections of the PV power sources to attain a desired voltage. Further, the battery management system can configure one or more parallel connections of series connections of the PV power sources. The series connections of the PV sources can be configured to attain the desired voltage, and the parallel connections of the series of PV power sources can be configured to attain the desired amperage. In addition to configuring the PV power sources, the battery management system controls PV and battery power delivery to a load.

In embodiments, the configuring enables PV power source power point tracking. The power point tracking can include maximum power point tracking (MPPT). The MPPT can include techniques that can be applied to power sources such as PV power sources. The MPPT techniques enable a maximum power extraction from the PV power sources as the power output of the power sources changes over time. The power output can vary due to sunlight intensity, angle of incidence of sunlight onto the power source, ambient temperature, physical condition of the power source, and so on. Maximum power point tracking can be based on impedance matching between the power source and the power load. Further, the characteristics of a load that can be driven by the PV power sources can vary. In embodiments, the power point tracking can provide source current/load voltage impedance matching. The MPPT can be accomplished by presenting an optimal load to the PV power sources. The optimal load can be provided by a circuit. The output voltage, output current, and, when the output includes an AC output, output frequency can be adjusted to one or more of a required voltage, required output current, and output frequency. In embodiments, the impedance matching can provide a local optimum power transfer operating point.

The system 700 can include a computer program product embodied in a non-transitory computer readable medium for power management, the computer program product comprising code which causes one or more processors to perform operations of: accessing a plurality of photovoltaic (PV) power sources, wherein the plurality of PV power sources is configured using one or more series connections, and wherein each PV power source of the plurality of PV power sources includes voltage sensing and current sensing; enabling bypassing each PV power source of the plurality of PV power sources, wherein the bypassing occurs at each PV power source, and wherein the bypassing is performed by a distributed controller-switch at each PV power source; coupling a battery management system to the plurality of PV power sources, wherein the battery management system provides a configurable variable load voltage to the plurality of PV power sources; monitoring the voltage and the current that are sensed at each PV power source of the plurality of PV power sources; and configuring the bypassing of each PV power source of the plurality of PV power sources and the variable load voltage of the battery management system, wherein the configuring enables PV power source power point tracking.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for power management comprising:
accessing a plurality of photovoltaic (PV) power sources, wherein the plurality of PV power sources is configured using one or more series connections, and wherein each PV power source of the plurality of PV power sources includes voltage sensing and current sensing;
enabling bypassing each PV power source of the plurality of PV power sources, wherein the bypassing occurs at each PV power source, and wherein the bypassing is performed by a distributed controller-switch at each PV power source;
coupling a battery management system to the plurality of PV power sources, wherein the battery management system provides a configurable variable load voltage to the plurality of PV power sources;
monitoring the voltage and the current that are sensed at each PV power source of the plurality of PV power sources; and
configuring the bypassing of each PV power source of the plurality of PV power sources and the variable load voltage of the battery management system, wherein the configuring enables PV power source power point tracking.

2. The method of claim 1 further comprising controlling each distributed controller-switch using a system controller.

3. The method of claim 2 wherein the system controller is integrated in the battery management system.

4. The method of claim 3 wherein the battery management system controls PV and battery power delivery to a load.

5. The method of claim 4 wherein the battery management system controls power delivery to the load through an inverter.

6. The method of claim 1 wherein the power point tracking provides source current/load voltage impedance matching.

7. The method of claim 6 wherein the impedance matching provides a local optimum power transfer operating point.

8. The method of claim 1 wherein each of the plurality of PV power sources comprises a solar panel.

9. The method of claim 1 wherein the accessing, the enabling, the coupling, the monitoring, and the configuring provide a solar management system.

10. The method of claim 1 further comprising coupling overload protection devices between the plurality of PV power sources and the battery management system.

11. The method of claim 10 wherein the overload protection devices prevent an overvoltage condition at the battery management system.

12. The method of claim 10 wherein the overload protection devices prevent an overcurrent condition at the battery management system.

13. The method of claim 1 wherein each distributed controller-switch comprises a bypass switch, a series switch, one or more sensors, and a control module.

14. The method of claim 13 wherein the bypass switch and the series switch comprise insulated-gate bipolar transistor switches.

15. The method of claim 13 further comprising coupling each distributed controller-switch to the battery management system.

16. The method of claim 15 wherein the coupling enables system control of each distributed controller-switch.

17. The method of claim 13 wherein the one or more sensors enable the monitoring.

18. The method of claim 13 wherein the control module enables the configuring.

19. The method of claim 1 wherein the configuring further controls total voltage delivery for the plurality of PV power sources and the battery management system.

20. The method of claim 19 wherein the total voltage delivery and the PV power source power point tracking are balanced against a power delivery metric.

21. The method of claim 1 wherein the bypassing enables PV power source in situ repair.

22. A computer program product embodied in a non-transitory computer readable medium for power management, the computer program product comprising code which causes one or more processors to perform operations of:
accessing a plurality of photovoltaic (PV) power sources, wherein the plurality of PV power sources is configured using one or more series connections, and wherein each PV power source of the plurality of PV power sources includes voltage sensing and current sensing;
enabling bypassing each PV power source of the plurality of PV power sources, wherein the bypassing occurs at each PV power source, and wherein the bypassing is performed by a distributed controller-switch at each PV power source;
coupling a battery management system to the plurality of PV power sources, wherein the battery management system provides a configurable variable load voltage to the plurality of PV power sources;
monitoring the voltage and the current that are sensed at each PV power source of the plurality of PV power sources; and
configuring the bypassing of each PV power source of the plurality of PV power sources and the variable load voltage of the battery management system, wherein the configuring enables PV power source power point tracking.

23. A computer system for power management comprising:
a memory which stores instructions;
one or more processors coupled to the memory, wherein the one or more processors, when executing the instructions which are stored, are configured to:
access a plurality of photovoltaic (PV) power sources, wherein the plurality of PV power sources is configured using one or more series connections, and wherein each PV power source of the plurality of PV power sources includes voltage sensing and current sensing;
enable bypassing each PV power source of the plurality of PV power sources, wherein the bypassing occurs at each PV power source, and wherein the bypassing is performed by a distributed controller-switch at each PV power source;
couple a battery management system to the plurality of PV power sources, wherein the battery management system provides a configurable variable load voltage to the plurality of PV power sources;
monitor the voltage and the current that are sensed at each PV power source of the plurality of PV power sources; and
configure the bypassing of each PV power source of the plurality of PV power sources and the variable load voltage of the battery management system, wherein the configuring enables PV power source power point tracking.
